(19) United States
(12) Patent Application Publication
(10) Pub. No.: US 2022/0067078 A1
(43) Pub. Date: Mar. 3, 2022

(54) Aggregation system, Response Summary Process, and Method of Use

(71) Applicant: Medoid AI PC, Thessalonik (GR)

(72) Inventor: Anestis Fachantidis, Thessaloniki (GR)

(21) Appl. No.: 17/464,586

(22) Filed: Sep. 1, 2021

Related U.S. Application Data
(60) Provisional application No. 63/073,470, filed on Sep. 2, 2020.

(51) Int. Cl. G06F 16/35; G06F 16/332; G06F 16/33; G06N 20/00; G06Q 30/02

(52) U.S. Cl. CPC G06F 16/358; G06F 16/3328; G06Q 30/0203; G06N 20/00; G06F 16/3331

(57) ABSTRACT

A technology that aggregates and summarizes multiple textual responses given to a single and specific stimulus (e.g., a question). This aggregation process results in a single short text that has been made so that it expresses the meaning of most of the responses given. An intuitive allegory for this is the following: If a number of people were collectively writing a single common response to a stimulus what would that response be? There are three user roles of this technology namely the “Researcher”, the “Respondent” and the “Observer” which all of them are not mutually exclusive. The Researcher (I) is the user providing the stimulus, the Respondent (II) is a user responding to that stimulus with a written response, and the observer (III) is a user that is simply interested in observing the process and obtaining a single aggregated response to the stimulus given.

### SEQUENCE LISTING OR PROGRAM

Not Applicable

### TECHNICAL FIELD OF THE INVENTION

The present invention generally relates to an aggregation system, response summary process, and method of use. More specifically, and without limitation, this disclosure relates to a system for summarizing a plurality of responses given to a single stimulus. The present invention more specifically relates to an aggregation system for summarizing a plurality of responses resulting from a plurality of textual inputs and the generation of a single response that would summarize all the plurality of responses, and methods of use.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document: Copyright Medoid AI. All rights reserved.

### BACKGROUND OF THE INVENTION

Data is a well-known item in the art. Data is a characteristic or characteristics of information. Typically, data, being plural, is collected through passive or active observation. Active observation being the active collection of data while passive observation is the input of data from other sources without the interaction from the collector of data.

In the specification the terms “data” and “information” are often used interchangeably. However, these terms have distinct meanings. Data tends to be variables, qualitative, or quantitative in nature that is turned into information. Furthermore, data may be measured, collected, reported, and analyzed. Turning data into information involves analysis and can often be extremely complex. Data is typically manipulated for understanding. The most common forms of data manipulation in order to provide an understanding of data is through graphs, images, or other analysis tools, including but not limited to, providing statistics. In all of these circumstances, data is turned into another form for the purpose of representation and interpretation.

Data management is a valuable resource and concept that is well known in the art and emerged in more complex facets with the advent of computers and more complex processing abilities. Data management is the organization of data so that data can be process and manipulated for showing data trends and interpreting data for various purposes.

Summarizing and/or synthesizing data has grown in complexity in the art. Data summarization and manipulation is an imperfect art. Statistics and various helpful information can be generated from the summarization of data. However, no matter how data is manipulated, the data can be misleading. The interpretation of data in modem data management is imperfect. Manipulation of data, by definition, requires changing the data as it is represented. This means the data must be represented in a new way that differs from its original format. In many circumstances, this manipulation can be helpful. However, this manipulation often leads to misleading statistics or misrepresentations of data which result in debates over the interpretation of the data and a debate over whether information is an accurate representation and/or a true representation of the meaning of the data.

Surveys are old and well known in the art. Surveys or surveying is a sampling technique and/or methodology which is used in sampling and gaining information from individuals related to almost any subject human input may be needed on. This collection of data from a population for the purpose and/or gathering of information may be a variety of information. Some example of the information gathered in a survey may be polls related to politics, public opinion polls on a variety of subjects, market research and/or marketing analytics for sales and the like, public health surveys, government surveys, demographic information gathering, and much much more, which could include studies or analytics on almost any imaginable topic.

A survey, as disclosed and taught by the present invention, may be a statistical survey or a research survey and is often used to gather inputs from humans. Every human speaks or provides input and or information for a survey in a different manner. These various inputs are sometimes impossible to synthesize into a common understanding or interpretation. Complicating matters further, surveys tend to have varying stimuli. These stimuli are interpreted differently from individual to individual. The result is that a stimuli may cause an individual to respond to a stimulus in a dramatically different way and approach than another individual or group of individuals.

For these reasons, surveys, especially human surveys which often involve questions and answers are very complex. Surveys with questions and/or questionnaires typically involve literal questions which can range from a few words to paragraphs of description. These questions act a stimulus for the reader, which may not even be the respondent. In some cases, others may be filling out surveys, and the like. The questions, or stimuli present a challenge in the interpretation of various words, the combination of those words, images, and/or stimuli.

The answers provided in open ended questions within questionnaires are very complex. Open ended questions can elicit a wide variety of response types, having various lengths, various word complexities, and the like. Sometimes researchers may spend hours reading through answers to understand a feedback or to be able to derive a cohesive understanding of the feedback. Currently, only humans are capable of handling this type of analysis which creates interpretations of data and the tedious task of research through various questionnaires.

For this reason, there exists a need in the art for a processing system which can accept a plurality of data input and generate a single output in the same format of the input in a way which properly represents a plurality of inputs both as a manipulation but in the same format.

More specifically, there exists a need in the art for an automatic aggregation and summarization system which can process a plurality of textual inputs and produce a cohesive, singular output which accurately represents the plurality of textual inputs. Said another way, there exists a need in the art for a technology that aggregates and summarizes a plurality of textual responses given to a single and specific stimulus, such as a question, and produces a result expressed in a single, short text. In this way, and in this single short text, the system generates an output which expresses clearly and concisely a summary of the responses that were provided to the stimulus, whether in the questionnaire or in another setting. In this way, a researcher can quickly understand a plurality of responses, even a great number of responses provided.

### Definitions

Unless stated to the contrary, for the purposes of the present disclosure, the following terms shall have the following definitions:

Administrators, commonly known as admins or sysops (system operators), are software or system users who have been granted the technical ability to perform certain special actions.

“Application software” is a set of one or more programs designed to carry out operations for a specific application. Application software cannot run on itself but is dependent on system software to execute. Examples of application software include MS Word, MS Excel, a console game, a library management system, a spreadsheet system etc. The term is used to distinguish such software from another type of computer program referred to as system software, which manages and integrates a computer's capabilities but does not directly perform tasks that benefit the user. The system software serves the application, which in turn serves the user.

The term “app” is a shortening of the term “application software”. It has become extremely popular and in 2010 was listed as “Word of the Year” by the American Dialect Society

“Apps” are generally available through application distribution platforms, which began appearing in 2008 and are typically operated by the owner of the mobile operating system. Some apps are free, while others must be bought. Usually, they are downloaded from the platform to a target device, but sometimes they are downloaded to laptops or desktop computers.

“API” In computer programming, an application programming interface (API) is a set of routines, protocols, and tools for building software applications. An API expresses a software component in terms of its operations, inputs, outputs, and underlying types. An API defines functionalities that are independent of their respective implementations, which allows definitions and implementations to vary without compromising each other.

A client is a piece of computer hardware or software that accesses a service made available by a server. The server is often (but not always) on another computer system, in which case the client accesses the service by way of a network. The term applies to programs or devices that are part of a client-server model.

“Electronic Mobile Device” is defined as any computer, phone, smartphone, tablet, or computing device that is comprised of a battery, display, circuit board, and processor that is capable of processing or executing software. Examples of electronic mobile devices are smartphones, laptop computers, and tablet PCs.

A gateway is a link between two computer programs or systems. A gateway acts as a portal between two programs allowing them to share information by communicating between protocols on a computer or between dissimilar computers.

“GUI”. In computing, a graphical user interface (GUI) sometimes pronounced “gooey” (or “gee-you-eye”)) is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces (CLIs), which require commands to be typed on the keyboard.

The Hypertext Transfer Protocol (HTTP) is an application protocol for distributed, collaborative, hypermedia information systems. HTTP is the foundation of data communication for the World Wide Web. Hypertext is structured text that uses logical links (hyperlinks) between nodes containing text. HTTP is the protocol to exchange or transfer hypertext.

The internet of things, or IoT, is a system of interrelated computing devices, mechanical and digital machines, objects, animals, or people that are provided with unique identifiers (UIDs) and the ability to transfer data over a network without requiring human-to-human or human-to-computer interaction.

The Internet Protocol (IP) is the principal communications protocol in the Internet protocol suite for relaying datagrams across network boundaries. Its routing function enables internetworking, and essentially establishes the Internet.

An Internet Protocol address (IP address) is a numerical label assigned to each device (e.g., computer, printer) participating in a computer network that uses the Internet Protocol for communication. An IP address serves two principal functions: host or network interface identification and location addressing.

An Internet service provider (ISP) is an organization that provides services for accessing, using, or participating on the Internet.

iOS (originally iPhone OS) is a mobile operating system created and developed by Apple Inc. and distributed exclusively for Apple hardware. It is the operating system that presently powers many of the company's mobile devices, including the iPhone, iPad, and iPod touch.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

A “mobile device” is a generic term used to refer to a variety of devices that allow people to access data and information from wherever they are. This includes cell phones and other portable devices such as, but not limited to, PDAs, Pads, smartphones, and laptop computers.

A “module” in software is a part of a program. Programs are composed of one or more independently developed modules that are not combined until the program is linked. A single module can contain one or several routines or steps.

A “module” in hardware, is a self-contained component.

An operating system (OS) is software that manages computer hardware and software resources and provides common services for computer programs. The operating system is an essential component of the system software in a computer system. Application programs usually require an operating system to function.

Push Notification, Push, or server push describes a style of Internet-based communication where the request for a given transaction is initiated by the publisher or central server. It is contrasted with pull/get, where the request for the transmission of information is initiated by the receiver or client.

The “Researcher” is the user providing the stimulus.

The “Respondent” is a user responding to that stimulus with a written response.

A server is a running instance of an application (software) capable of accepting requests from the client and giving responses accordingly. Servers can run on any computer including dedicated computers, which individually are also often referred to as “the server”.

A “software application” is a program or group of programs designed for end users. Application software are divided into two general classes: systems software and applications software. Systems software consists of low-level programs that interact with the computer at a considerably basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used. A software module is defined as a series of process steps stored in an electronic memory of an electronic device and executed by the processor of an electronic device such as a computer, pad, smart phone, or other equivalent device known in the prior art.

A “software application module” is a program or group of programs designed for end users that contains one or more files that contains instructions to be executed by a computer or other equivalent device.

A “smartphone” (or smart phone) is a mobile phone with more advanced computing capability and connectivity than basic feature phones. Smartphones typically include the features of a phone with those of another popular consumer device, such as a personal digital assistant, a media player, a digital camera, and/or a GPS navigation unit. Later smartphones include all of those plus the features of a touchscreen computer, including web browsing, wideband network radio (e.g., LTE), Wi-Fi, 3rd-party apps, motion sensor and mobile payment. URL is an abbreviation of Uniform Resource Locator (URL), it is the global address of documents and other resources on the World Wide Web (also referred to as the “Internet”).

A “User” is any person registered to use and using the computer system executing the method of the present invention.

In computing, a “user agent” or “useragent” is software (a software agent) that is acting on behalf of a user. For example, an email reader is a mail user agent, and in the Session Initiation Protocol (SIP), the term user agent refers to both end points of a communications session. In many cases, a user agent acts as a client in a network protocol used in communications within a client-server distributed computing system. In particular, the Hypertext Transfer Protocol (HTTP) identifies the client software originating the request, using a “User-Agent” header, even when the client is not operated by a user. The SIP protocol (based on HTTP) followed this usage.

The “Viewer” is a user that is simply interested in observing the process and obtaining that single response to the stimulus given

A “web application” or “web app” is any application software that runs in a web browser and is created in a browser-supported programming language (such as the combination of JavaScript, HTML, and CSS) and relies on a web browser to render the application.

A “website”, also written as Web site, web site, or simply site, is a collection of related web pages containing images, videos, or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as webpage is a document, typically written in plain text interspersed with formatting instructions of Hypertext Markup Language (HTML, XHTML). A web page may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal. The pages of a website can usually be accessed from a simple Uniform Resource Locator (URL) called the homepage. The URLs of the pages organize them into a hierarchy, although hyperlinking between them conveys the reader's perceived site structure and guides the reader's navigation of the site.

### SUMMARY OF THE INVENTION

The disclosure herein presents an aggregation system, response summary process, and methods of use wherein if a plurality of people were collectively writing a single, common response to a stimulus, the system herein generates the result of that single common response.

Thus, it is a primary object of this disclosure to provide an aggregation system, response summary process, and methods of use that summarize a plurality of stimuli responses into a single response that aggregates all and/or most of the responses. The present disclosure provides this solution and more, as will become apparent herein.

The present invention is an aggregation system, response summary process, and method of use is presented. The aggregation system, response summary process, and method of use is presented herein transforms a plurality of textual inputs and produces a cohesive, singular, easy to understand output which accurately represents the plurality of textual inputs.

Furthermore, the present disclosure aggregates and summarizes a plurality of textual responses given into a single and specific stimulus. The disclosure herein, then produces a single expressed result. The product may be changed to a variety of product types. In one embodiment, a single text result is generated. In this way, a plurality of responses can be read and understood with minimal time and effort.

In one example, the aggregation system, response summary process, and method of use collects a plurality of responses from a stimulus, from a plurality of individuals or plurality of groups of individuals. These responses may be responses to a single stimulus, or a plurality of responses to a plurality of stimuli. The system herein then generates the result of the responses as a single response for each stimulus. Additionally, a single response can be generated from responses to different stimuli.

In another one example, the system collects textual responses to a single stimulus. The system then processes the textual responses. The aggregation system manipulates the plurality of textual responses to create a single output in the form of a text response. The text response appears in a similar length and style to the plurality of responses. The single output text response accurately represents an understanding of what a human would understand after reading all of the responses. For example, what the “majority” said or even more what groups or clusters of responses exist in the responses with the single response representing the most frequent of these.

Thus, it is a primary object of the disclosure to provide an aggregation system, response summary process, and method of use that can provide an easy to understand, singular response as if a plurality of people were collectively writing a single, common response to a stimulus, by generating a singular, easy to understand response.

### REFERENCE NUMERALS

10—System
11 User
12 Graphical User Interface
13—Plurality of Accounts
14—Database
16—Plurality of Datasets
18—Plurality of Projects
20—Researcher
21—Login
22—Username
23—Password
24—Stimulus
25 Publishing
26—Authentication Mechanism
28—Database of responses 3
0—Individual Response (of 28)
32—Aggregated Response (of 28)
34 Statistics (of 28)
36—Confidence Metric (of 28)
38—Quality Index (of 28)
40—Analytics of responses
42—Opinion Leader Stats
44 End Aggregation Feature
46—New Response Acceptance Feature
48—Backend Information
50—Service Provider
52—Graphical User Interface
60—Respondent
62—Login Information
64—Username
66—Password
68—Demographic Information
70—Interaction Sequence
72—Graphical User Interface
74—Login Page
76—Username
78—Password
80—Stimulus Page
82—Stimulus
84—Input Box
86—Send Input Feature
88 Live Presentation of aggregate
90—Response
92—Remove Feature
94—Add Feature
96—Reenforce Feature
98—Submit Feature
100—Graphical User Interface
102—Response Page
103—Stimulus
104—Text Box
105—Current Aggregated Response
106—New Response
107 Submit Feature
110—Observer
120—Opinion Leader
121—Opinion Leader Feature
122—Gamification
124—Response Influence Rating
126—Variance Rating Factor
128—Convergence Factor
130—Final Result Comparison Feature
132 Alter Opinion Leader
134 Response Variance Influencer
136—Alternate Response Branch
140—Related Response Factor
142—Similar Response Factor
144 Broadness Leader
200—Summarization Engine
202—Input
204 Processor
206—Output
208—Improved Result
210—End Result
220—Application Server
222—Mobile Application
230—Remote Server
240—Computer

### BRIEF DESCRIPTION OF THE DRAWINGS

The accompanying drawings, which are incorporated herein form a part of the specification, illustrate the present invention and, together with the description, further explain the principles of the invention and to enable a person skilled in the pertinent art to make and use the invention.

FIG. 1 is a flow chart illustrating the system of the present invention.

FIG. 2 illustrates the user arrangement as taught by the present invention.

FIGS. 3-4 illustrate a one researcher arrangement taught by the present invention.

FIG. 5 illustrates the one respondent process as taught by the present invention.

FIG. 6 illustrates the one opinion leader process as taught by the present invention.

FIG. 7 illustrates an alter and/or alternate opinion leader process as taught by the present invention.

FIG. 8 illustrates the summarization engine as taught by the present invention.

FIG. 9 illustrates the application server as taught by the present invention.

FIG. 10 illustrates the computer system as taught by the present invention for enablement of the method and processes.

FIG. 11 is chart illustrating the transparency level of the process and visibility rights of the observer and respondent roles and point of view in the system taught by the present invention.

FIG. 12 illustrates the overall flow and connectivity of each component of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention is practiced. These embodiments are described in sufficient detail to enable those skilled in the art to practice the invention, but other embodiments are utilized, and logical, mechanical, electrical, and other changes are made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention is practiced without these specific details. In other instances, well-known structures and techniques known to one of ordinary skill in the art have not been shown in detail in order not to obscure the invention. Referring to the figures, it is possible to see the various major elements constituting the apparatus of the present invention.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM). an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“SaaS”»), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module. segment, or portion of code, which comprises one or more executable instructions for implementing the specified logical function(s).

It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

Aggregation system, response summary process, and method of use may be formed of any suitable size, shape, and design and is configured to change the state of the art of the data gathering, data planning, data information supply, and information processing of modem surveying processes and other data interpretation processes. The disclosure herein is configured to integrate with various platforms and/or accept various inputs and/or various documents to allow users to scale information into a single response or a set of responses by dynamically modifying components of input of each individual response to a stimulus.

By allowing a user to input various information in its component parts, the disclosure herein is able to modify each component part individually, tailoring it to the needs of the researcher and/or user. In this way, the disclosure herein can take a survey project and/or information and/or other project information gathered in a data set as input and simplify and improve the data input into a single, easy to understand output in a way that can be quickly understood by a set of users. Here, the information received as input could be a survey question as part of a survey project or a social media post or poll, which would be another exemplary possible stimulus.

Embodiments of the present disclosure include systems and methods that automatically pull all of the responses and/or information gathered to stimuli, such as all of the textual inputs to a stimuli, from a comprehensive database containing a myriad of information about the responses including, but not limited to, name, address, age, and other demographic information related to the respondent, researcher information, variance information, input type information, date of entry, modification percentages, and more.

Furthermore, the disclosure herein, for the first time, allows a user with no statistical knowledge or data gathering knowledge the ability to solicit data and/or solicit knowledge and/or complete the process of data manipulation and data understanding in a cohesive method so as to understand results of a survey and/or results of input.

Additionally, and in other words, the aggregation system, response summary process, and method of using disclosed herein provide a system that presents data aggregation such that if a number of people were collectively writing a single common response to a stimulus, the aggregation system would provide this response.

With respect to the present invention as taught and explained, a summary or an aggregations precisely means that of people responding on a single question/stimuli the system can take the following: Each individual respondent normally considers some aspects of the topic raised by the stimuli/questions and they have a specific sentiment for each aspect.

Each individual respondent's response normally considers some aspects of the topic raised by the stimuli/questions. Also, each response has a specific sentiment for each aspect.

For Example: If the question/stimuli is “What do you think about VOLVO XC60?” Some person will talk about its engine (aspect) and say it is good (sentiment), some other person will talk about its safety (aspect) and say he is not feeling very confident about it (sentiment). In the instances when a third person may want to talk about both these aspects, they may or may not have a different sentiment for each, etc.

The system of the present invention, unlike prior art solutions, doesn't just summarize blindly, but identifies each and every aspect discussed in the responses and their respective sentiments and then, based on this internal categorization, produces the single text following a principle like: “for the most frequent aspects, the most frequent sentiments.” The aggregation system, response summary process and method of use provides for a user to collect and integrate data and information, including but not limited to, contact information, survey information, variance information, and more without having an intimate knowledge of the data collected. Furthermore, the disclosure herein allows rapid input of stored information into and/or configured in a database. Furthermore, the disclosure herein provides rapid assimilation of these inputs and real time processing of the information and the integration of that new information with the live overall output generated.

Furthermore, new users can be added with a minimal amount of configuration. In other words, new users, who have very specific locales or unique demographics, and more, can be integrated into the disclosure herein, the disclosure herein configuring and needs of each new project and/or new user and/or new researcher and/or new respondent and/or new observer. This rapid assimilation of the new user provides for instant use with the disclosure herein, and instant assimilation into data information and output management.

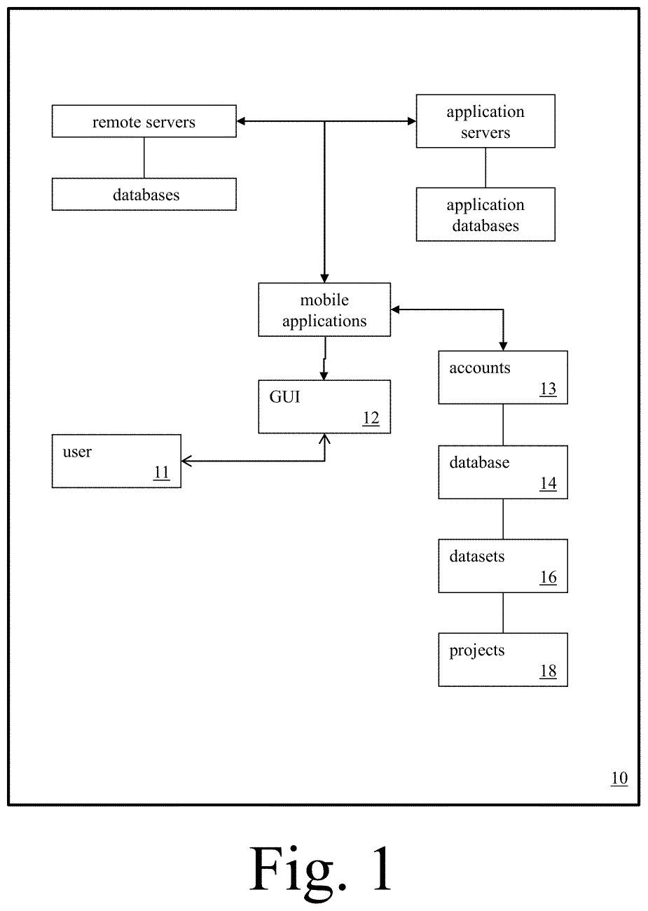

Now referring to FIG. 1, the system of the present invention is illustrated. With reference to the figures, an aggregation system, response summary process 10 and methods of use are presented (hereafter known as “aggregation system”, “response summary system”, “response summary process”, “information system”, or simply “system”). Information system 10 is formed of any suitable size, shape, and design. In the arrangement shown, as one example, aggregation system 10, which may comprise remote servers, databases, application servers, application databases, mobile applications, and/or computers that fulfill the functions disclosed herein, also includes, in the embodiment(s) depicted includes a user 11. a graphical user interface 12, a plurality of accounts 13, a database 14, a plurality of datasets 16, and a plurality of projects 18, among other components.

In the arrangement shown, as one example, system 10 may comprise remote servers, databases, and/or computers that fulfill the functions disclosed and described herein. The appearance of the presentation of project information and/or the process windows for uploading and/or adding information to project documents may vary. As one example, in one embodiment, the appearance of windows and/or the process for data gathering, data uploading, data manipulation, data management, data recording, and the like, and adding information, and storing information is disclosed herein.

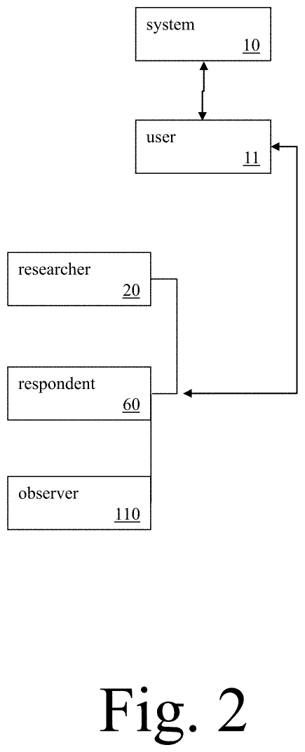

Now referring to FIG. 2, one user arrangement taught by the present invention is illustrated. In the arrangement shown in FIG. 2, as one example, a user 11 may be any person and/or entity interacting with system 10. In the arrangement shown, as one example, user 11 is primarily one of three types of users including, but not limited to, a researcher 20, a respondent 60, and an observer 110. While these three users and their methods of use are primarily discussed herein, user 11 may be others interacting with system 10 in various manners and using various methods of use.

Researcher:

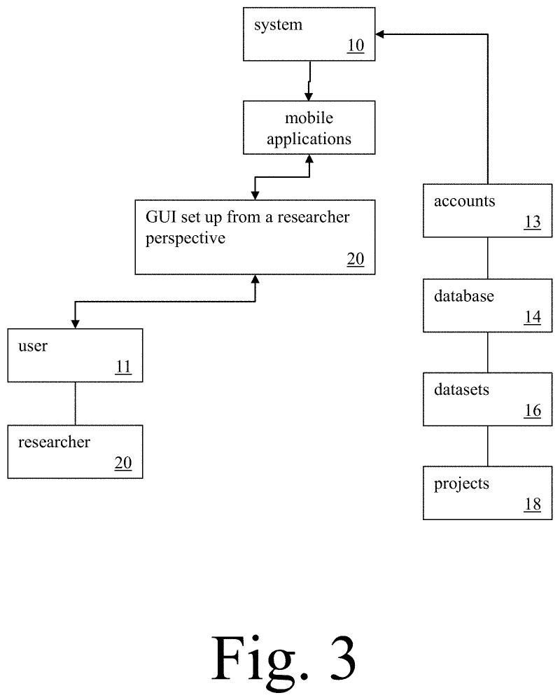

Now referring to FIG. 3, one researcher arrangement taught by the present invention is illustrated. In the arrangement shown in FIG. 3, as one example, system 10 and a method of use includes a researcher 20. Researcher 20 may be any user wishing to gather a specific set of data about any project or a plurality of projects 18. In the arrangement shown, as one example, researcher 20 has a graphical user interface 52 which is set up from a researcher 20 perspective.

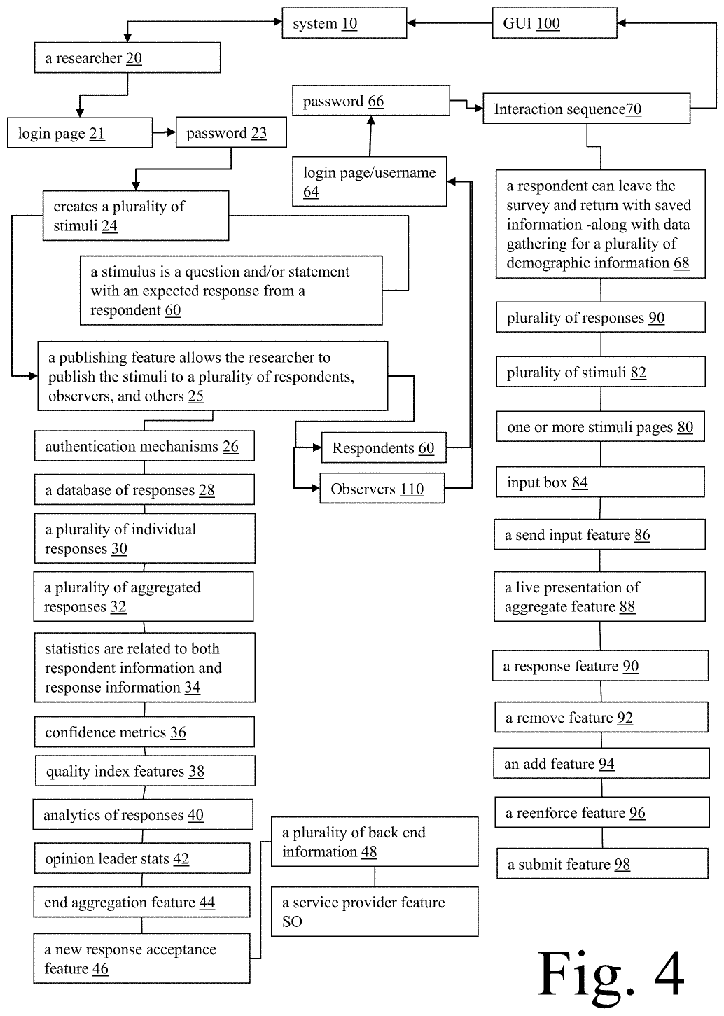

In the arrangement shown in FIG. 4, as one example, a researcher 20 interface includes a login page 21, a username 22, and a password 23. Not all embodiments require a login. However, in the primary interaction, and in the arrangement shown herein, as one example, once a researcher has signed into the system, the researcher 20 creates a plurality of stimuli 24. In the arrangement shown, as one example, a stimulus is a question and/or statement with an expected response from a respondent 60. Once the researcher 20 has created a stimulus or plurality of stimuli 24, the researcher 20 publishes the stimulus. The researcher 20 has access to the backend of system 10 such that the researcher 20 can access various information, including but not limited to, individual responses, aggregate responses generated by the summarization engine, confidence statistics, aggregation confidence numbers, quality index summarizations, segments of responses based on their content, other special analytics, and access to opinion leaders (to be further discussed herein).

In the arrangement shown, as one example, a stimuli 24 is in the form of a question or statement. In this way, the question or statement elicits a response from a user. However, stimuli 24 may be formed of anything or event which evokes a response from a user. Other examples of stimuli include, but are not limited to, pictures, imagery, videos, sounds, smells, physical touch, a combination thereof, and the like.

In the arrangement shown, as one example, once the aggregation process has a new response and acceptance has been concluded by the researcher 20, the researcher 20 can interact with and/or manipulate the data and/or responses received. In this way, the researcher 20 can see the aggregate response and/or aggregated response generated by the crown box engine. The researcher also can see the opinion leaders and/or alternate opinion leaders. In this way, the researcher 20 can see responses that generated new aggregate responses and or a new branch of responses in addition to the primary branch of responses. In this way, a researcher 20 can gain a more comprehensive view and/or understanding of the responses and/or response meanings. Furthermore, the researcher 20 can see a variety of confidence metrics and/or accuracy metrics which convey the confidence and/or accuracy of the information.

Additionally, and in the arrangement herein, as one example, researcher 20 interactions and functionality also includes a publishing 25 feature—publishing feature 25 allows the researcher 20 to publish the stimuli to a plurality of respondents 60, observers 110, and others authentication mechanisms 26, a database of responses 28, a plurality of individual responses 30, a plurality of aggregated responses 32, various statistics 34—statistics 34 are related to both respondent 60 information and response information—confidence metrics 36, quality index features 38, analytics of responses 40, opinion leader stats 42, end aggregation feature 44, a new response acceptance feature 46, a plurality of back end information 48, and a service provider feature SO, among other features, components, and functionality.

In the arrangement shown, as one example, system 10 and a method of use includes a respondent 60. Respondent 60 may be any user responding to a plurality of stimuli which have been published by a researcher 20 and/or a plurality of researchers 20. In the arrangement shown, as one example, respondent 60 has a graphical user interface 100 which is set up from a respondent 60 perspective.

In the arrangement shown, as one example, respondent 60 interface includes a login page 62, a username 64, a password 66—which exist for account creation such that a respondent can leave the survey and return with saved information—along with data gathering for a plurality of demographic information 68—as prepared by a researcher 20. Additionally, and in the arrangement shown, as one example, a respondent page 61 includes an interaction sequence 70 which dictates the order in which a respondent 60 interacts with system 10. Not all embodiments require a login. However, in the primary interaction, and in the arrangement shown herein, as one example, once a respondent has signed into the system, the respondent 60 can submit a plurality of responses 90 to the provided plurality of stimuli 82—which may be found on a stimulus page 80 or a plurality of stimuli pages 80.

In the arrangement shown, as one example, a stimulus is a question and/or statement with an expected response from a respondent 60. Once the researcher 20 has created a stimulus or plurality of stimuli 24, the researcher 20 publishes the stimulus. The respondent 60 has access to the stimulus such that the respondent can reply to the stimulus providing the researcher 20 with various information, including but not limited to, individual responses, aggregate responses generated by the summarization engine, confidence statistics, aggregation confidence numbers, quality index summarizations, other special analytics, and access to opinion leaders (to be further discussed herein).

Additionally, and in the arrangement herein, as one example, respondent 60 interactions and functionality also includes an input box 84, a send input feature 86, a live presentation of aggregate feature 88, a response feature 90, a remove feature 92, an add feature 94, a reenforce feature 96, a submit feature 98, among other features, components, and functionality.

Respondent Process:

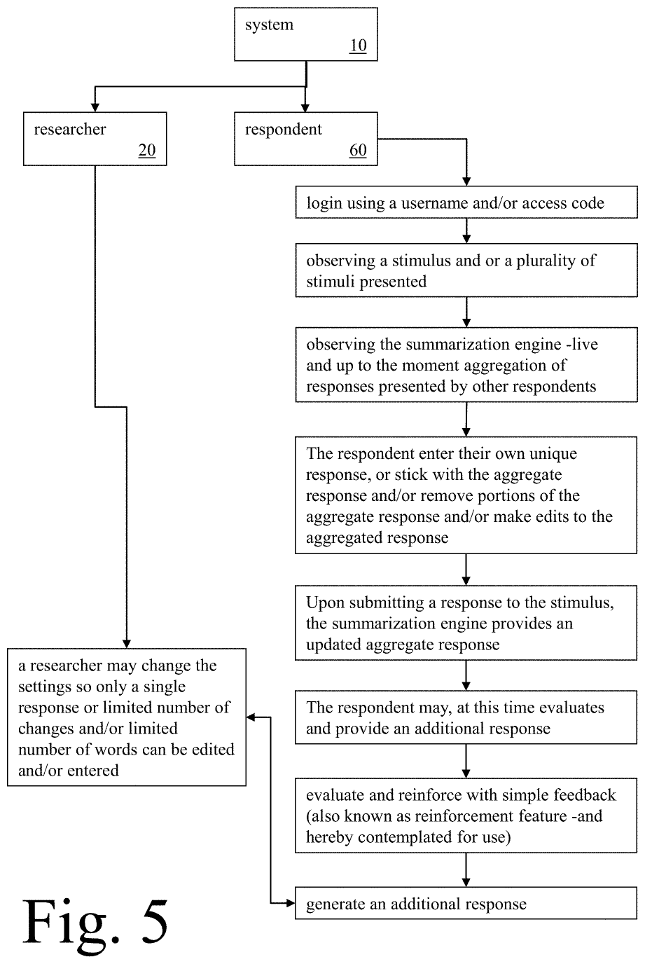

Now referring to FIG. 5, one respondent process taught by the present invention is illustrated. In the arrangement shown, as one example, the respondent interacts with system 10 by first observing a stimulus and or a plurality of stimuli presented. This may take place after a login using a username and/or access code. In the same context of observing the stimulus, a respondent may observe the summarization engine—live and up to the moment aggregation of responses presented by other respondents. In this way. the respondent can enter their own unique response or stick with the aggregate response and/or remove portions of the aggregate response and/or make edits to the aggregated response.

In this situation, the respondent will not alter the actual aggregated response, in this situation the respondent uses that text, modifies it, maybe, and submits it again. Then the system generates a new aggregated response which might have been influenced by the respondent's response. For example, if the response was something new or different from the previously displayed or presented actual aggregated response.

In one exemplary embodiment of the present invention, it is always one question or one thing in general, to which a response is received. As previously discussed, one question may have different aspects as perceived by each respondent. Additionally, in some instances the respondent or the observer may see a plurality of responses, which would then include the responses of the others.

Upon submitting a response to the stimulus, the summarization engine (to be further discussed herein) provides an updated aggregate response. The respondent may, at this time, evaluate and provide an additional response. In this way, respondent may evaluate and reinforce with simple feedback (also known as reinforcement feature—and hereby contemplated for use). Some feedback, for example, may be a like feature, an emphasis feature, a highlight feature, and the like. In an alternative embodiment, the respondent may generate an additional response, if desired. These features, and others can be adjusted by the researcher. For example, a researcher may change the settings so only a single response or limited number of changes and/or limited number of words can be edited and/or entered.

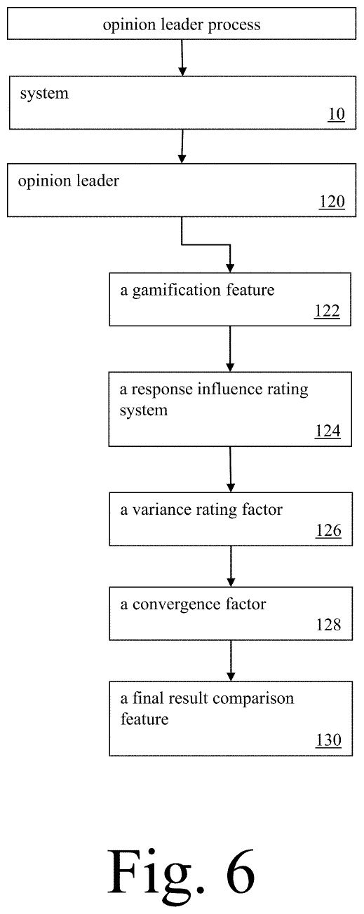

Now referring to FIG. 6, one opinion leader process taught by the present invention is illustrated. In the arrangement shown, as one example, system 10 includes an opinion leader 120. Opinion leader 120 is any respondent who has a majority representation response that is the most accurate representation and/or contributes the most to the aggregate response. Said another way, the opinion leader 120 is a respondent or a plurality of respondents who have a response that has strongly influenced the aggregated result and/or have generated a response which has affected the aggregate response in a distinct way. Said another way, the opinion leader 120 can be identified by a response that has reduced the variance of the aggregate response and/or converged the aggregate response closer to what is the ultimate response. Furthermore, the opinion leader functionality provides a gamification element to system 10.

In addition to the above, opinion leader features include a gamification feature 122, a response influence rating system 124, a variance rating factor 126, a convergence factor 128, and a final result comparison feature 130, among other features, components, and functionality.

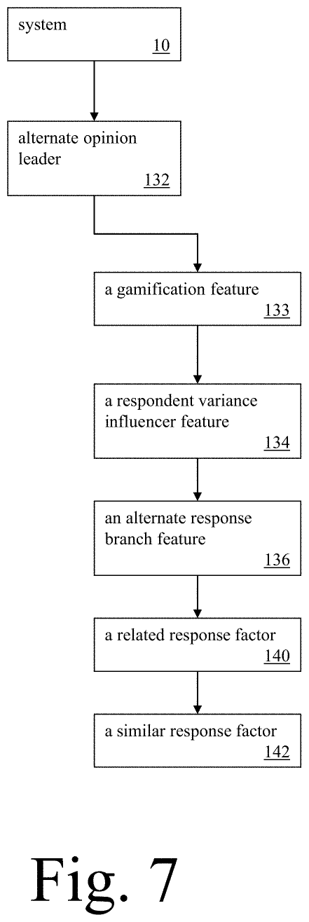

In addition, and in the arrangement shown, as one example, system 10 includes an alter and/or alternate opinion leader as illustrated by FIG. 7. An alternative opinion leader 132 is a respondent who delivers a response which makes the aggregation and/or summary of a response more difficult. Said another way, an alternative opinion leader 132 is a respondent who delivers a response to a stimulus which has an increased variance factor from the aggregation of responses and or aggregate response. In the arrangement shown, as one example, system 10 includes a feature which creates a secondary branch of responses based on a predetermined variance or threshold or a learned variance or threshold.

The variance rating of a response is the extent that a response has reduced the variance of responses after it was publicly input, in other words, the next peoples' responses were very agreeable to that one and very similar (reduced overall variance of the responses' content). In other words, if the variance rating is above a predetermined threshold and/or machine learned threshold, then a second branch of responses is created such that the integrity of the first aggregation of responses is not compromised or is allowed to continue.

In addition to the above, alternative opinion leader features include a gamification feature 133, a respondent variance influencer feature 134, an alternate response branch feature 136, a related response factor 140, and a similar response factor 142, among other features, components, and functionality.

In addition, in the arrangement shown, as one example, system 10 includes a broadness leader 144. Broadness leader 144 is a respondent who has entered a response that has the smallest variance of the aggregate response. In other words, the broadness leader 144 is a respondent who has the lowest variance threshold. Said another way, the broadness leader is the respondent with the most similar response to the response, as if it was “predicted”, which is the end result of the aggregation of the responses generated by the summarization engine.

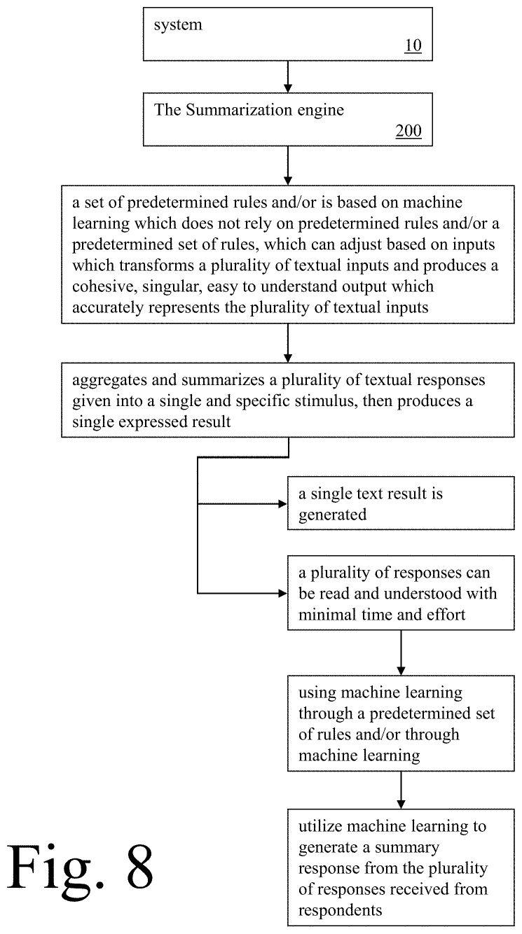

Now referring to FIG. 8, the summarization engine taught by the present invention is illustrated. In the arrangement shown, as one example, system 10 includes a summarization engine 200. The Summarization engine 200 is formed of any suitable size, shape and design and is configured to generate a single response and or branches of responses from a plurality of inputs. Said another way, the summarization engine 200 includes a set of predetermined rules and/or is based on machine learning which does not rely on predetermined rules and/or a predetermined set of rules, which can adjust based on inputs which transforms a plurality of textual inputs and produces a cohesive, singular, easy to understand output which accurately represents the plurality of textual inputs. Furthermore, and in the arrangement shown herein, summarization engine 200 aggregates and summarizes a plurality of textual responses given into a single and specific stimulus, then produces a single expressed result. The product may be changed to a variety of product types. In one embodiment, a single text result is generated. In this way, a plurality of responses can be read and understood with minimal time and effort.

Furthermore, in the arrangement shown, as one example, the summarization engine 200 uses machine learning through a predetermined set of rules and/or through machine learning. In this way, the summarization engine 200 can utilize machine learning to generate a summary response from the plurality of responses received from respondents.

It is important to point out and ensure the reader does not mistakenly consider the teaching of the present invention as just summarization. The present invention additionally utilizes an aspect and sentiment identification process as well, which clearly illustrates that the present invention is not just a simple summarization output method or process, but that the method and process taught herein as the present invention truly and really analyzes the texts for its output generation.

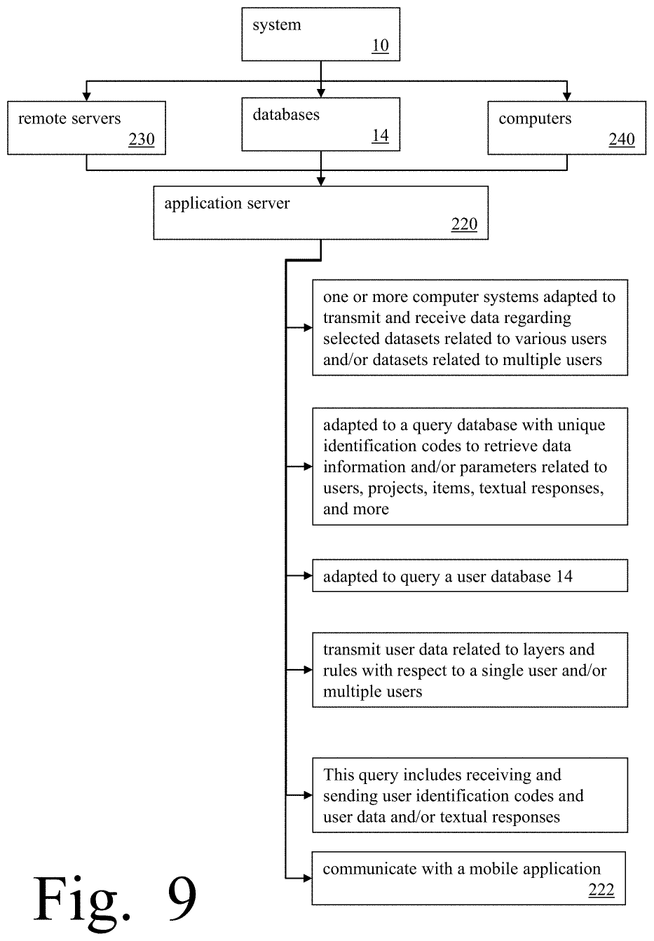

Now referring to FIG. 9, the application server taught by the present invention is illustrated. In the arrangement shown, as one example, system 10 comprises remote servers 230, databases 14, and/or computers 240 that fulfill the functions disclosed and described herein. In the embodiment depicted, system 10 comprises at least one application server 220. Application server 220 comprises one or more computer systems adapted to transmit and receive data regarding selected datasets related to various users and/or datasets related to multiple users. Application server 220 is adapted to a query database with unique identification codes to retrieve data information and/or parameters related to users, projects, items, textual responses, and more.

The Application server 220 may transmit user data related to layers and rules with respect to a single user and/or multiple users. Application server 220 is also adapted to query a user database 14. This query includes receiving and sending user identification codes and user data and/or textual responses. Additionally, the application server 220 may communicate with a mobile application 222, which is adapted to present the user information in a form conducive to being viewed on a mobile device and/or handheld device.

As one of ordinary skill in the art may understand, application server 220, project database, and other databases mentioned herein may be implemented in one or more servers. Furthermore, each may be on multiple servers to increase system efficiency, especially when handling large data gathering, data organizing, such as handling global positioning of a user, following extended rules for various functionality of system 10 and/or processing, updating user information, including various responses entered.

Additionally, multiple servers may have mirrored data to prevent data loss in case of disk failure and/or to decrease access and response times for database queries. In alternative embodiments, application server 220, and other database procedures may be carried out on computer-readable instructions and data stored on the customer's mobile computing device.

Additionally, system 10 may include a remote server 230, a computing system 240, includes an application programming interface (“API”) which includes tools and resources enabling a user to operate the embodiments herein, and a cloud computing system.

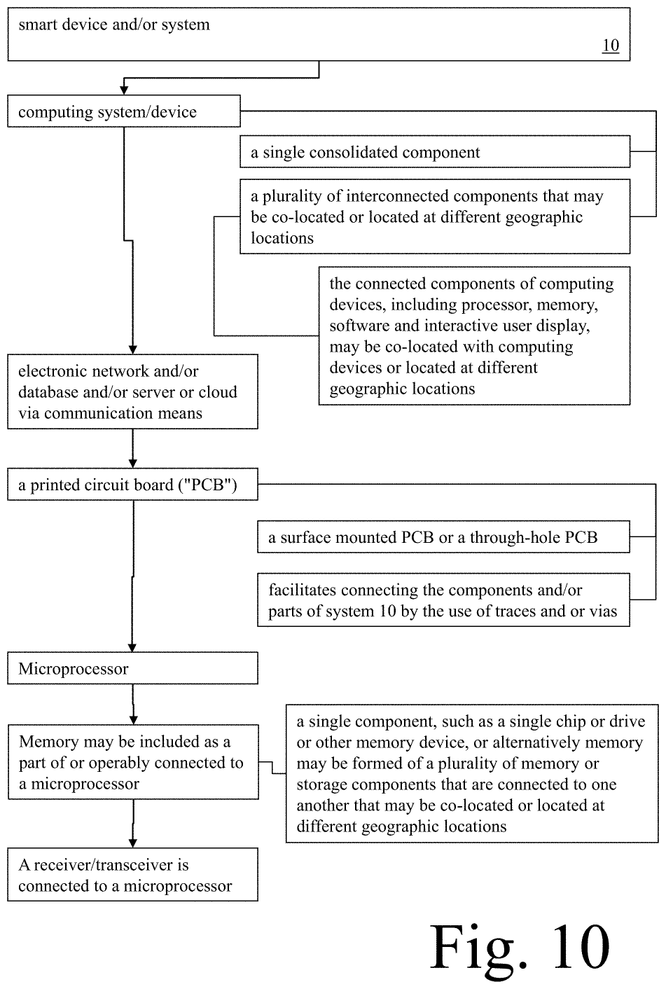

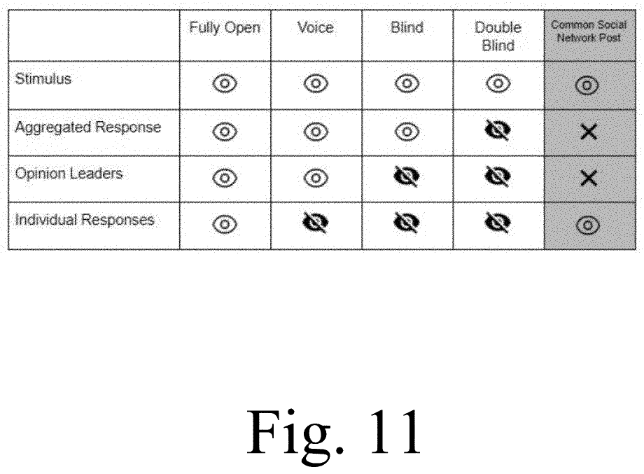

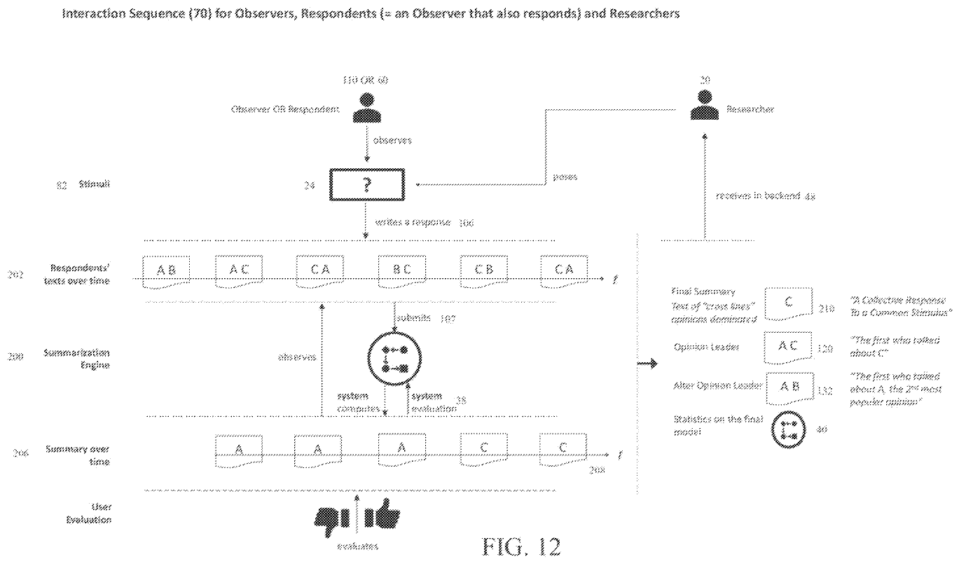

Now referring to FIG. 10, the computing system taught by the present invention is illustrated. In one arrangement, as is shown, smart device and/or system 10 includes computing system. Computing system is formed of any suitable size, shape, and design and configured to handle computing operations, as are necessary for the operation of the computing functionality of system 10. Computing system may be connected with electronic network and/or database and/or server or cloud via communication means and includes a processor, a memory, a microcontroller, a printed circuit board, a microprocessor, a receiver/transceiver, among other components.

Computing device may be formed of any computing device capable of displaying and manipulating data in the manners described herein. Computing devices may include for example a desktop computer, a laptop computer, a tablet, smart phone, or any other computing device or other interactive device.

Computing device may be a single consolidated component, or alternatively, computing devices may be formed of a plurality of interconnected components that may be co-located or located at different geographic locations. Computing devices may be cloud based or it may be hardware based, or cloud capable. In addition, the connected components of computing devices, including processor, memory, software, and interactive user display, may be co-located with computing devices, or located at different geographic locations. That is, computing devices may be made of any form of a device or system that individually or collectively performs the computing operations of system 10.

Printed Circuit Board: In the arrangement shown, as one example, system 10 includes a printed circuit board (“PCB”). PCB is formed of any suitable size, shape and design and is configured to facilitate carrying and/or holding other components and/or parts necessary to carry out various computation and/or related functions of system 10. PCB, as one example, might be a surface mounted PCB or a through-hole PCB. PCB, as one example, is green and facilitates connecting the components and/or parts of system 10 by the use of traces and or vias. Traces are formed of any suitable size, shape and design and are configured as lines electrically connecting the components and/or parts of system 10. Vias are formed of any suitable size, shape and design and are configured as holes that connect layers of traces together. Generally, as in shown, traces and vias are soldered to connect the components and/or parts to the PCB.

Microprocessor: Microprocessor is any computing device that receives and processes information and outputs commands according to instructions stored in memory. Memory is any form of information storage such as flash memory, RAM memory, a hard drive, or any other form of memory. Memory may be included as a part of or operably connected to a microprocessor. A receiver/transceiver is connected to a microprocessor. A receiver is used if one way communication is utilized, whereas a transceiver is used if two-way communication is utilized (hereinafter “transceiver”).

Memory: In the arrangement shown, as on example, system 10 includes a memory. Memory may be formed of any suitable size, shape and design and is configured to facilitate selective storage and retrieval of data (including data) in association with computing device, processor, software, and interactive user display. Memory may be a single component, such as a single chip or drive or other memory device, or alternatively memory may be formed of a plurality of memory or storage components that are connected to one another that may be co-located or located at different geographic locations.

In Operation: As one example, and in the arrangement shown, as one example, system 10 is designed to provide an aggregation system and response summary process. More specifically and without limitation, in operation the system 10 provides for the aggregation of a plurality of responses and the process of summarizing a plurality of responses.

In an alternative embodiment of the present invention an aggregation system, response summary process, and method of use that aggregates multiple textual responses.

In an alternative embodiment of the present invention an aggregation system, response summary process, and method of use that aggregates multiple responses given to a single stimulus.

In an alternative embodiment of the present invention an aggregation system, response summary process, and method of use that aggregates multiple responses given to a plurality of stimuli.

In an alternative embodiment of the present invention an aggregation system, response summary process, and method of use that aggregates multiple textual responses given to a single and specific stimulus, such as a question.

In an alternative embodiment of the present invention an aggregation system, response summary process, and method of use that summarizes multiple textual responses given to a single stimulus.

In an alternative embodiment of the present invention an aggregation system, response summary process, and method of use that summarizes multiple responses to a plurality of stimuli.

In an alternative embodiment of the present invention an aggregation system, response summary process, and method of use that summarizes multiple textual responses given to a single and specific stimulus, such as a question.

In an alternative embodiment of the present invention an aggregation system, response summary process, and method of use that produces a single response. In an alternative embodiment of the present invention an aggregation system, response summary process, and method of use that produces a single short text which expresses the meaning of most of the responses.

In an alternative embodiment of the present invention an aggregation system, response summary process, and method of use that provides a response which appears as if a number of people were collectively writing a single common response to a stimulus.

In an alternative embodiment of the present invention an aggregation system, response summary process, and method of use that provides a graphical user interface for a researcher. In an alternative embodiment of the present invention an aggregation system, response summary process, and method of use that provides a graphical user interface for a respondent. In an alternative embodiment of the present invention an aggregation system, response summary process, and method of use that provides a graphical user interface for an observer.

In an alternative embodiment of the present invention an aggregation system, response summary process, and method of use that provides a stimulus staging interface. In an alternative embodiment of the present invention an aggregation system, response summary process, and method of use that provides a response collection mechanism. In an alternative embodiment of the present invention an aggregation system, response summary process, and method of use that provides an observation mechanism. In an alternative embodiment of the present invention an aggregation system, response summary process, and method of use that provides a stimulus publication mechanism.

In an alternative embodiment of the present invention an aggregation system, response summary process, and method of use that provides an authentication mechanism. In an alternative embodiment of the present invention an aggregation system, response summary process, and method of use that provides various statistics.

In an alternative embodiment of the present invention an aggregation system, response summary process, and method of use that provides a quality index. In an alternative embodiment of the present invention an aggregation system, response summary process, and method of use that provides special analytics on the responding process. In an alternative embodiment of the present invention an aggregation system, response summary process, and method of use that provides up to date information on opinion leaders.

In an alternative embodiment of the present invention an aggregation system, response summary process, and method of use that provides up to date information on opinion leaders emerging from the responses.

In an alternative embodiment of the present invention an aggregation system, response summary process, and method of use that provides user flexibility in ending or beginning research at any time.

In an alternative embodiment of the present invention an aggregation system, response summary process, and method of use that provides for ease of observing the results as they come in. In an alternative embodiment of the present invention an aggregation system, response summary process, and method of use that provides for public surveying. In an alternative embodiment of the present invention an aggregation system, response summary process, and method of use that provides for private surveying.

Here, the stimuli may not only be a survey question, but a social media post or many other things. In one example the stimuli may be one or more FACEBOOK posts, or other social media applications where multiple comments are frequently associated or attached, which incorporate the aggregation method and process taught by the present invention beneath each individual post to summarize comments.

In an alternative embodiment of the present invention an aggregation system, response summary process, and method of use that provides a respondent with up-to-date information on responses, allowing respondent to edit responses in their way.

In an alternative embodiment of the present invention an aggregation system, response summary process, and method of use that allows a respondent to reinforce a response.

In an alternative embodiment of the present invention an aggregation system, response summary process, and method of use that provides recomputing and/or reprocessing with each additional response.

In an alternative embodiment of the present invention an aggregation system, response summary process, and method of use that provides an opinion leader feature. In an alternative embodiment of the present invention an aggregation system, response summary process, and method of use that provides a gamification element.

In an alternative embodiment of the present invention an aggregation system, response summary process, and method of use that provides for identifying individuals who have influenced the results more than others.

In an alternative embodiment of the present invention an aggregation system, response summary process, and method of use that provides for identifying individuals who have influenced the summarization results more than others. In an alternative embodiment of the present invention an aggregation system, response summary process, and method of use that identifies an individual's impact on a response. In an alternative embodiment of the present invention an aggregation system, response summary process, and method of use that provides a variance rate for a response.

In an alternative embodiment of the present invention an aggregation system, response summary process, and method of use that provides for alter opinion leaders. And In an alternative embodiment of the present invention an aggregation system, response summary process, and method of use that provides for broadness leaders.

In an alternative embodiment of the present invention an aggregation system, response summary process, and method of use that provides for multiple branches of response based on predetermined variation numbers.

In an alternative embodiment of the present invention an aggregation system, response summary process, and method of use that provides a stimulus box. In an alternative embodiment of the present invention an aggregation system, response summary process, and method of use that provides a textbox that can be edited and modified.

In an alternative embodiment of the present invention an aggregation system, response summary process, and method of use that provides varying transparency levels. In an alternative embodiment of the present invention an aggregation system, response summary process, and method of use that provides varying visibility rights to the users. In an alternative embodiment of the present invention an aggregation system, response summary process, and method of use that provides transparency and visibility combinations. In an alternative embodiment of the present invention an aggregation system, response summary process, and method of use that provides for improved surveying. In an alternative embodiment of the present invention an aggregation system, response summary process, and method of use that provides for improved data collection. In an alternative embodiment of the present invention an aggregation system, response summary process, and method of use that provides for improved data understanding. In an alternative embodiment of the present invention an aggregation system, response summary process, and method of use that provides for improved data interpretation. In an alternative embodiment of the present invention an aggregation system, response summary process, and method of use that provides improved data reporting.

In an alternative embodiment of the present invention an aggregation system, response summary process, and method of use that provides a single, easy to understand data interpretation.

In an alternative embodiment of the present invention an aggregation system, response summary process, and method of use that provides data understanding without changing data into different formats.

In an alternative embodiment of the present invention an aggregation system, response summary process, and method of use that provides live data updates. In an alternative embodiment of the present invention an aggregation system, response summary process, and method of use that provides machine learning.

In an alternative embodiment of the present invention an aggregation system, response summary process, and method of use that provides varying levels of access. In an alternative embodiment of the present invention an aggregation system, response summary process, and method of use that improves upon the state of the art.

In an alternative embodiment of the present invention an aggregation system, response summary process, and method of use that is efficient. In an alternative embodiment of the present invention an aggregation system, response summary process, and method of use that is robust. In an alternative embodiment of the present invention an aggregation system, response summary process, and method of use that is accurate. These and other objects, features, or advantages of the present disclosure will become apparent from the specification and claims.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are resorted to, falling within the scope of the invention.

The embodiments of the invention in which an exclusive property or privilege is claimed are defined as follows:

1. An aggregation system summarizing a plurality of responses, comprising the steps of:
providing a computing system;
providing a project server;
providing a project database having at least one dataset;
providing a graphical user interface for
data gathering,
data uploading,
data manipulation,
data management,
data recording,
adding information, and
storing information;
adding one or more stimuli;
comparing and managing the plurality of stimuli;
collecting a plurality of responses from a plurality of respondents;
generating an aggregated response based on a plurality of individual responses which accurately represents the plurality of responses;
evaluating the aggregated responses by the respondent's feedback to see if aggregated responses generated cover and/or match the respondents response; and
improving respondent evaluation by utilizing the system to improve the aggregation result.

2. The system of claim 1, further comprising the steps of:
aggregating and summarizing multiple textual responses given to a single and specific stimulus; and
the aggregation process results in a single short text that has been made so that it expresses the meaning of the peoples' most frequent sentiment on the most frequent aspects.

3. The system of claim 1, wherein the interface consists of the following set of graphical elements:
a stimulus box;
a textbox containing
the aggregated response and cannot be edited;
an empty space where a new response can be written or entered; and/or
the current aggregated response which can be edited to modify the aggregated response to a new original response of a Respondent; and
a submit button.

4. The system of claim 1, wherein the aggregation system is comprised of
one or more remote servers,
one or more databases,
one or more application servers,
one or more application databases,
one or more mobile applications, and/or
one or more computers that fulfill the method and process steps herein.

5. The system of claim 1, wherein
system users are characterized as
a researcher,
a respondent, and
an observer. 110.

6. The system of claim 5, wherein
a researcher is any user wishing to gather a specific set of data about any project or a plurality of projects; and
the system displays to a researcher a graphical user interface which is set up from a researcher perspective; and
a researcher interface includes a login page, a username, and a password.

7. The system of claim 6, wherein
once a researcher has signed into the system, the researcher creates a plurality of stimuli;
a stimulus is a question, social media post, and/or statement with an expected response from a respondent;
once the researcher has created a stimulus or plurality of stimuli, the researcher publishes the stimulus; and
the researcher has access to the backend of system such that the researcher accesses various information, including but not limited to,
individual responses,
aggregate responses generated by a summarization engine,
confidence statistics,
aggregation confidence numbers,
quality index summarizations, and
other special analytics, and access to opinion leaders.

8. The system of claim 5, wherein
a stimuli is in the form of a question or statement;
the question or statement elicits a response from a user; and
stimuli are formed of a question, a social media post, and/or a product review which evokes a response from a user.

9. The system of claim 5, wherein
once the aggregation process has new response acceptance has been concluded by the researcher,
the researcher interacts with and/or manipulates the data and/or responses received;
the researcher sees the aggregate response and/or aggregated response generated by the crown box engine;
the researcher also can see the opinion leaders and/or alternate opinion leaders;
the researcher sees responses that generated new aggregate responses and or a new branch of responses in addition to the primary branch of responses; and
the researcher sees a variety of confidence metrics and/or accuracy metrics which convey the confidence and/or accuracy of the information.

10. The system of claim 9, wherein
researcher interactions and functionality includes:
a publishing feature which allows the researcher to publish the stimuli to a plurality of respondents, observers 110, and others
authentication mechanisms,
a database of responses,
a plurality of individual responses,
a plurality of aggregated responses,
statistics related to both respondent information and response information;
confidence metrics,
quality index features,
analytics of responses,
opinion leader stats,
end aggregation feature,
a new response acceptance feature,
a plurality of backend information, and
a service provider feature.

11. The system of claim 5, wherein
a respondent page includes an interaction sequence which dictates the order in which a respondent interacts with system;
once a respondent has signed into the system, the respondent can submit one response to the provided plurality of stimuli which may be found on a stimulus page or a plurality of stimuli pages;
respondent interactions and functionality include,
an input box,
a send input feature,
a live presentation of aggregate feature,
a response feature,
a remove feature,
an add feature,
a reenforce feature, and
a submit feature.

12. The system of claim 11, wherein
once the researcher has created a stimulus or plurality of stimuli, the researcher publishes the stimulus;
the respondent has access to the stimulus such that the respondent can reply to the stimulus providing the researcher with various information, including but not limited to,
individual responses,
aggregate responses generated by the summarization engine,
confidence statistics,
aggregation confidence numbers,
quality index summarizations,
other special analytics, and
access to opinion leaders.

13. The system of claim 11, wherein
the respondent interacts with system by first observing a stimulus and or a plurality of stimuli presented;
a respondent observes the summarization engine which presents live and up to the moment aggregation of responses presented by other respondents;
the respondent can enter their own unique response, or stick with the aggregate response and/or remove portions of the aggregate response and/or make edits to the aggregated response;
upon submitting a response to the stimulus, the summarization engine provides an updated aggregate response; and
the respondent optionally evaluates and provides an additional response.

14. The system of claim 11, wherein
the opinion leader is any respondent who has a majority representation response that is the most accurate representation and/or contributes the most to the aggregate response; and
the opinion leader is a respondent or a plurality of respondents who have a response that has strongly influenced the aggregated result and/or have generated a response which has affected the aggregate response in a distinct way.

15. The system of claim 14, wherein
the opinion leader features include
a gamification feature,
a response influence rating system,
a variance rating factor,
a convergence factor, and
a final result comparison feature.

16. The system of claim 11, further comprising
an alternative opinion leader is a respondent who delivers a response to a stimulus which has an increased variance factor from the aggregation of responses and or aggregate response;
creating a secondary branch of responses based on a predetermined variance or threshold or a learned variance or threshold; and
if the variance rating is above a predetermined threshold and/or machine learned threshold, then a second branch of responses is created such that the integrity of the first aggregation of responses is not compromised or is allowed to continue.

17. The system of claim 16, wherein the alternative opinion leader features include
a gamification feature,
a respondent variance influencer feature,
an alternate response branch feature,
a related response factor, and
a similar response factor.

18. The system of claim 11, further comprising
a broadness leader who is a respondent who has entered a response that has the smallest or lowest variance of the aggregate response.

19. The system of claim 7, wherein
the summarization engine includes a set of predetermined rules and/or is based on machine learning which does not rely on predetermined rules and/or a predetermined set of rules, which can adjust based on inputs which transforms a plurality of textual inputs and produces a cohesive, singular, easy to understand output which accurately represents the plurality of textual inputs;
the summarization engine aggregates and summarizes a plurality of textual responses given into a single and specific stimulus, then produces a single expressed result.

20. The system of claim 19, wherein
the summarization engine generates a single text result whereby a plurality of responses can be read and understood with minimal time and effort.

21. The system of claim 20, wherein
the summarization engine 2 uses machine learning through a predetermined set of rules to generate a summary response from the plurality of responses received from respondents.
